(19) United States
(12) Patent Application Publication
(10) Pub. No.: US 2010/0159229 A1
(43) Pub. Date: Jun. 24, 2010

(54) REMOVAL OF BULGE EFFECTS IN NANOPATTERNING

(76) Inventors: Chae-Ho Shin, Gwanak-gu (KR); In-Su Jeon, Jung-gu (KR); Zheong Gou Khim, Yongin-si (KR)

Correspondence Address: SHERR & VAUGHN, PLLC, 620 HERNDON PARKWAY, SUITE 320, HERNDON, VA, 20170, US

(21) Appl. No.: 12/534,015

(22) Filed: Jul. 31, 2009

(30) Foreign Application Priority Data
Jul. 31, 2008 (KR) 10-2008-0075162

(51) Int. Cl. B32B 3/26; B29C 59/02

(52) U.S. Cl. 428/304.4; 264/293; 977/887

(57) ABSTRACT

A nanostructure without bulges and a method of fabricating the nanostructure are provided. The method includes forming a nanopattern on a surface of a polymer, allowing the surface of the polymer with the nanopattern to come into contact with a predetermined solvent, and applying an external stimulus to the surface of the polymer in contact with the solvent to remove bulges around the nanopattern formed during formation of the nanopattern. Accordingly, the bulges of the nanostructure where the nanopattern is formed may be removed at a low cost and in a simple manner.

### TECHNICAL FIELD

The described technology relates generally to nanostructures and, more particularly, to nanostructures without bulges and to techniques for removing the bulges produced during nanopatterning.

### BACKGROUND

Along with recent trends in miniaturization of devices, much research has been conducted on the fabrication of nanostructures and nanodevices. Typical methods employed to form fine patterns include a photolithography method and an electron beam lithography method. Although the electron beam lithography method is suitable for producing fine patterns without the use of a pattern mask, this method is both very expensive and complicated. Also, since the size of a beam spot on the equipment itself is fixed (usually at about 100 nm), there is a limit to forming a line width on the order of nanometers to tens of nanometers.

A possible alternative to these methods is AFM indentation, according to which a line width on the order of tens of nanometers or less can be formed by a simple method at a specific position by applying a force to an AFM tip. For an example of the application of this technology, K. Wiesauer and G. Springholz, J. Appl. Phys., 88, 7289 (2000) discloses a method of forming a semiconductor nanostructure by performing indentation on a photoresist layer deposited on a semiconductor substrate, and performing reactive ion etching using the photoresist pattern as a mask. Also, Carrey et al., Appl. Phys. Lett., 81, 760 (2002) discloses a technique for forming a nanocontact by performing nanoindentation to form a hole in an insulating photoresist layer deposited on various types of electrical conductors and filling the hole with metal. However, when AFM indentation is performed on a polymer layer such as a photoresist layer, a hole is formed and a bulge is formed around the hole as well.

### SUMMARY

In one embodiment, a method of fabricating a nanostructure to produce a nanopattern without bulges is provided. The method includes forming a nanopattern on a surface of a polymer, allowing the surface of the polymer with the nanopattern to come into contact with a predetermined solvent, and applying an external stimulus to the surface of the polymer in contact with the solvent to remove bulges around the nanopattern formed during formation of the nanopattern.

In another embodiment, a nanostructure without bulges around a nanopattern is provided. The nanostructure includes a substrate, and a polymer layer with a nanopattern formed on the substrate, wherein the bulges around the nanopattern are removed by applying a predetermined solvent and an external stimulus.

The Summary is provided to introduce a selection of concepts in a simplified form that are further described below in the Detailed Description. The Summary is not intended to identify key features or essential features of the claimed subject matter, nor is it intended to be used as an aid in determining the scope of the claimed subject matter.

### BRIEF DESCRIPTION OF THE DRAWINGS

The above and other features and advantages of the present disclosure will become more apparent to those of ordinary skill in the art by describing in detail example embodiments thereof with reference to the attached drawings in which:

FIG. 1 is a flowchart illustrating a method of fabricating a nanostructure according to one embodiment;

FIG. 2 is a cross-sectional view schematically illustrating a method of fabricating a nano structure according to one embodiment;

FIG. 3 shows a surface atomic force microscope (AFM) image when nanoindentation is carried out on a silicon substrate coated with polymethyl methacrylate (PMMA);

FIG. 4 is a cross-sectional view schematically illustrating a nanopattern before and after bulges around the nanopattern are removed;

FIG. 5 illustrates a procedure of fabricating a nanostructure in which a nanopattern is additionally formed in positions where bulges are removed;

FIG. 6 shows surface AFM images before and after a 10V direct current (DC) bias is applied according to the solvent compositions;

FIGS. 7A and 7B show surface and cross-sectional AFM images representing structures of holes and bulges according to various solvent compositions when the 10V DC bias is applied;

FIG. 8 is a graph illustrating changes in bulge height according to respective solvent compositions when the 10V DC bias is applied;

FIG. 9 is a graph illustrating changes in bulge height according to changes in DC bias;

FIGS. 10A and 10B show surface and cross-sectional AFM images representing structures of bulges and holes according to changes in DC and AC bias;

FIG. 11 shows surface AFM images before and after sonication according to solvent compositions; and

FIG. 12 shows AFM images before and after a surface treatment of sonication with respect to a PMMA surface patterned in a line shape using nanoindentation.

### DETAILED DESCRIPTION

It will be readily understood that the components of the present disclosure, as generally described and illustrated in the Figures herein, could be arranged and designed in a wide variety of different configurations. Thus, the following more detailed description of the embodiments of apparatus and methods in accordance with the present disclosure, as represented in the Figures, is not intended to limit the scope of the disclosure, as claimed, but is merely representative of certain examples of embodiments in accordance with the disclosure. The presently described embodiments will be best understood by reference to the drawings, wherein like parts are designated by like numerals throughout. Moreover, the drawings are not necessarily to scale, and the size and relative sizes of the layers and regions may have been exaggerated for clarity.

It will also be understood that when an element or layer is referred to as being “on” another element or layer, the element or layer may be directly on the other element or layer or intervening elements or layers may be present. As used herein, the term “and/or” may include any and all combinations of one or more of the associated listed items.

When nanopatterns are formed on a polymer surface by, for example, an atomic force microscope (AFM) indentation method, bulges may occur. The presence of the bulges may bring about numerous limits to the fabrication of nano-sized devices or fabrication of integrated circuits using self-assembly of nanoparticles or molecules.

According to the various embodiments of the present disclosure, bulges of a structure produced when nanopatterns are formed may be removed at a low cost and in a simple manner. Accordingly, lateral spacing between nanopatterns may be reduced so that extremely small patterns may be formed. Further, nanostructures having desired shapes and sizes may be fabricated according to process conditions described in the present disclosure, which may be applied to numerous nanodevices.

The term “bulge” as used herein refers to a polymer material which protrudes around a nanopattern when a polymer material is processed to form the nanopattern. The term “modified portion” as used herein refers to the polymer material other than the bulge, which is generated inside and outside of the nanopattern caused by impact in formation of the bulge. The term “nanoindentation” as used herein refers to techniques, including AFM indentation, for forming a dent hole on a surface using a sharp tip. The term “nanoimprinting” as used herein refers to techniques for compressing nano-stamps with nanopatterns having an unevenly imprinted shape onto a surface of an object to transfer the nanopatterns.

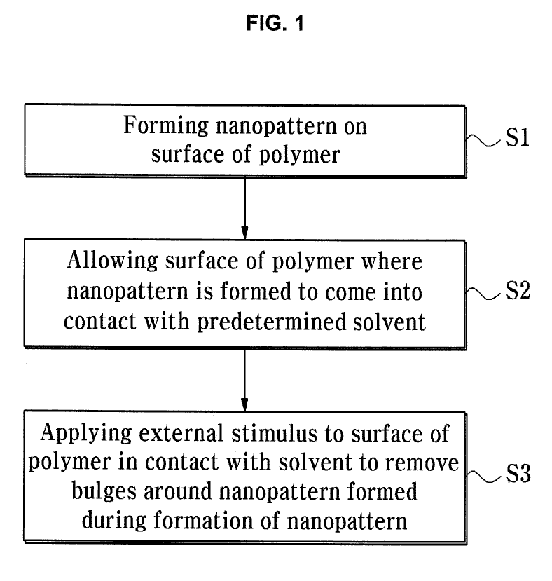

FIG. 1 is a flowchart illustrating a method of fabricating a nanostructure according to one embodiment. As illustrated, in step S1, a nanopattern is formed on a surface of a polymer. In step S2, the surface of the polymer with the nanopattern is allowed to come into contact with a solvent. In step S3, an external stimulus is applied to the surface of the polymer in contact with the solvent to remove bulges around the nanopattern. As a result, the nanostructure with the bulges being removed can be fabricated.

In other embodiments, processes including steps S1 to S3 may be repeated once or more times to form a nanostructure with numerous nanopatterns.

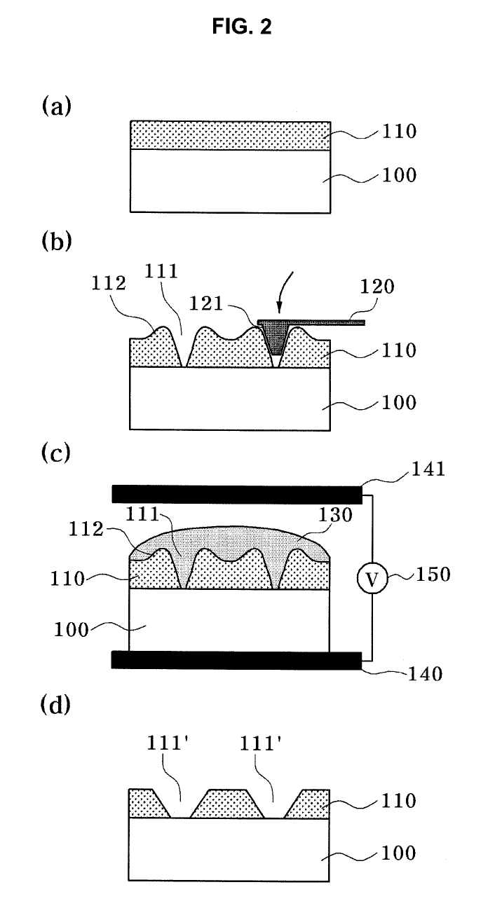

Each step of the method will be further described with reference to FIGS. 2 to 5 hereinafter.

FIG. 2 is a cross-sectional view schematically illustrating a method of fabricating a nanostructure according to one embodiment. Referring to (a) of FIG. 2, a substrate for nanopatterning is prepared in order to fabricate the nanostructure. A polymer substrate itself, or a substrate in which a polymer layer 110 is deposited on another substrate 100 as shown in (a) of FIG. 2, may be used as the substrate.

Any kind of polymer material may be used so long as the material may be easily processed for facilitating nanopatterning using a mechanical force, such as, by way of example and not a limitation, nanoindentation or nanoimprinting, and has an intensity, such as a constant intensity, suitable for maintaining patterns. The polymer material may include polyoxymethylene (POM), polyacryl (PA), polymethyl methacrylate (PMMA), polystyrene (PS) homopolymer or polystyrene (PS) copolymer, styrene acrylonitrile (SAN), acrylonitrile butadiene styrene (ABS), high impact polystyrene (HIPS), polycarbonate (PC), polyethylene (PE), polypropylene (PP) homopolymer or polypropylene (PP) copolymer, polyethylene terephthalate (PET), glycol-modified polyethylene terephthalate (PETG), polybutylene terephthalate (PBT), polyether-ester copolymers, polyether-amide copolymers, Nylon 6, Nylon 6,6, Nylon 6,10, Nylon 6,12, Nylon 11, Nylon 12, polyamide-imides, polyarylates, polyurethanes (PU), ethylene propylene rubber (EPR), ethylene propylene diene monomer (EPDM), polyarylsulfone (PAS), polyethersulfone (PES), polyphenylene sulfide (PPS), polyphenylene oxide (PPO), polyvinyl chloride (PVC), polysulfone (PS), polyetherimide (PEI), polytetrafluoroethylene (PTFE), fluorinated propylene ethylene, polyfluoroalkoxy, polychlorotrifluoroethylene (PCTFE), polyvinylidene fluoride (PVDF), polyvinyl fluoride (PVF), polyetherketone (PEK), polyetheretherketone (PEEK), polyetherketoneketone (PEKK), etc. These materials can be used alone or in various combinations thereof.

In one embodiment, micrometer-scale or nanometer-scale patterning, such as, by way of example, photolithography or electron beam lithography, is additionally carried out before or after the present nanopatterning. In the additional patterning, the polymer material may be used as a resist material such as a photoresist, an electron beam resist or an X-ray resist.

In one embodiment, PMMA is used as the electron beam resist. The PMMA is transparent, has soft physical properties, and has higher impact strength than glass. Moreover, when PMMA is employed, a secondary patterning may be further performed after a primary patterning. In this case, the primary patterning may be carried out by an electron beam lithography method and the secondary patterning may be performed by nanoindentation using a mechanical force. On the other hand, the primary fine patterning may be carried out using nanoindentation and the secondary hyperfine patterning may be carried out using the electron beam lithography method.

In cases where a polymer layer deposited on another substrate is used as a substrate, the polymer layer may be formed on a substrate by means of a coating method using a polymer solution dissolved in a proper solvent. For example, the polymer layer may be coated by well-known methods such as spray coating, dip coating, or spin coating.

The thickness of the polymer layer is not particularly limited, but may be changed by adjusting the concentration of the polymer solution and process variables according to desired uses and standards of nanopatterns, and may be 10 nm to 1,000 nm, or may be greater or smaller.

The types of substrate on which a film is coated is not particularly limited, and various organic and inorganic substrates including metals, polymers, silicon, sapphire, and so forth may be employed.

Referring to (b) of FIG. 2, a nanopattern is formed on the substrate on which the polymer is deposited. In this case, mechanical methods of forming the nanopattern may include, but are not necessarily limited to, a nanoindentation method or a nanoimprinting method. In addition, any method including optical, electrical, or chemical methods, as well as the mechanical method may be employed so long as bulges are formed around the nanopattern when the nanopattern is formed.

The nanopattern includes various structures including protruding or depressed structures formed on the polymer layer by various methods as described above.

In one embodiment, the nanoindentation method is carried out by a probe tip of the AFM. The nanoindentation may be carried out by a contact mode, a non-contact mode or a tapping mode AFM. Any mode may be used; whereas, the contact mode may cause the surface of the polymer to be damaged due to the probe tip and the non-contact mode may have an inaccurate image.

Referring again to (b) of FIG. 2, a dent hole 111 is formed on the surface of a polymer layer 110 determined by the movement of a probe 120 at a time of nanoindentation.

The shape of the dent hole 111 may depend on the shape of a probe tip 121 of the AFM. For example, the dent hole 111 may be circular when the tip 121 has a conical shape, and triangular when the tip 121 has a triangular pyramid shape. The dent hole 111 may be of various shapes, including square or rectangle, depending on the shape of the tip 121. In addition, the depth and diameter of the dent hole 111 may vary depending on the length and diameter of the tip 121. The tip 121 may be formed of various materials, such as, by way of example and not limitation, diamond or silicon, and may have a diameter in a range of 2 nm to 10 nm by way of example. Accordingly, the shape and size of the probe tip 121 may be properly selected according to the desired shape and size of the dent hole 111.

In addition, the diameter and the depth of the dent hole 111 may be increased with a stronger mechanical force at the time of nanoindentation. The diameter and the depth of the dent hole 111 may depend on a scanner extension value Δz and a spring constant of a cantilever.

The depth of the dent hole 111 may be no greater than the thickness of the polymer layer 110, and may be equal to the thickness of the polymer layer 110 to reach the lower substrate 100 as shown in FIG. 2.

The nanopatterning method employing nanoindentation enables fine patterning no greater than 10 nm to be implemented according to the diameter of the tip. Whereas, a mechanical force applied into the polymer layer 110 during nanoindentation pushes a portion of the polymer layer 110 to flow outward and around the dent hole 111 from the inside of the dent hole 111, resulting in a bulge 112, i.e., a protruding portion. In general, the nanoindentation allows the bulge 112 of about twice the size of the diameter of the dent hole 111 to be formed around the dent hole 111. For example, the bulge 112 may have a width of 20 nm when the dent hole 111 has the diameter of 10 nm. The presence of the bulge 112 indicates that the hole-hole spacing is required to be at least twice the diameter of the dent hole 111 for the nanopatterning, so that the presence of the bulge 112 may be a restriction factor against the nanopatterning. That is, the smallest lateral spacing may be determined by a sum of the widths of the dent hole 111 and the bulge 112. In addition, the protruding bulge 112 may prevent external nanoparticles from being injected into the dent hole 111 in a subsequent process.

Such phenomena may similarly occur in the nanoimprinting method employing mechanical patterning.

The height of the bulge may be several nanometers to several tens of nanometers by way of example. The height of the bulge formed around the hole after processing may be changed depending on the material and thickness of the polymer layer, the tip standard and mechanical force of the nanoindentation, and the stamp pattern and pressure conditions of the nanoimprinting.

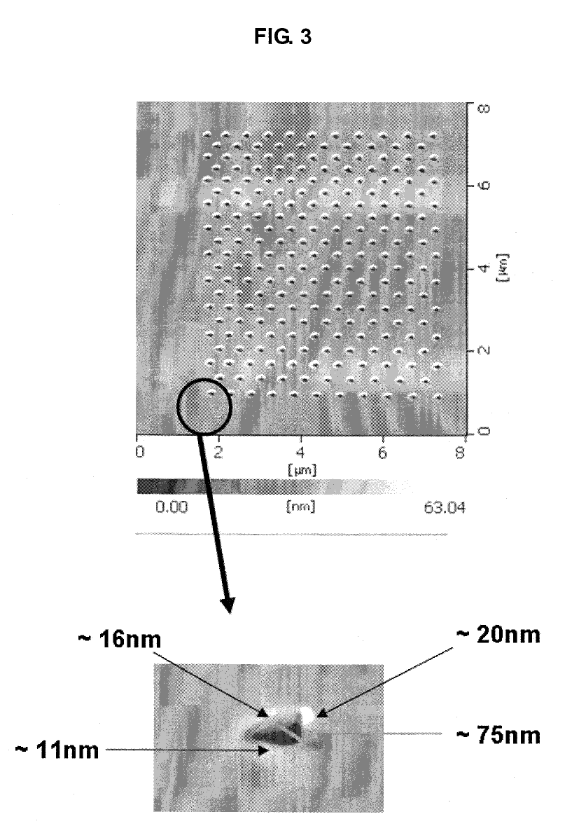

FIG. 3 shows an example of a surface AFM image when nanoindentation is carried out on a silicon substrate coated with PMMA. The PMMA (molecular weight=950 K, thickness=87 nm, root mean square (RMS)=0.3 nm) is formed on the silicon substrate using a spin coating method and several tens of dent holes are formed on the silicon substrate in an area approximately 8 μm×8 μm by performing the indentation thereon using a probe tip of a triangular pyramid (diameter=10 nm, k=42 N/m, f=330 KHz, scanner extension=80 nm). The shape of the dent holes is triangular, similar to the tip, and a protruding bulge formed around the hole is further illustrated from the enlarged view below. The hole diameter is about 75 nm, and the height of the bulge around the hole is asymmetrically distributed in a range of about 10 nm to about 20 nm.

Referring to (c) of FIG. 2, the polymer surface is then allowed to come into contact with a solvent and an external stimulus is applied to remove the bulge.

At this time, both the solvent and the external stimulus may be used instead of using the solvent or the external stimulus exclusively. This will be described in detail below.

A type and composition ratio of the solvent may be properly selected according to a corresponding polymer to allow the solvent to have a polarity sufficient to remove the bulge when the external stimulus is applied.

The proper type and polarity of the solvent suitable for removing the bulge may be selected to react with a predetermined portion of the polymer film when an electric field is applied into the polymer layer. Examples of the solvent may include water; an alcohol such as methyl alcohol, ethyl alcohol, n-propyl alcohol, isopropyl alcohol, n-butyl alcohol, sec-butyl alcohol, t-butyl alcohol, and isobutyl alcohol; a ketone such as acetone, methyl ethyl ketone, and diacetone alcohol; an ester such as ethyl acetate, and ethyl lactate; a polyhydric alcohol such as ethylene glycol, diethylene glycol, triethylene glycol, propylene glycol, butylene glycol, 1,4-butanediol, 1,2,4-butanetriol, 1,5-pentanediol, 1,2-hexanediol, 1,6-hexanediol, 1,2,6-hexanetriol, hexylene glycol, glycerol, glycerol ethoxylate, and trimethylolpropane ethoxylate; a lower alkyl ether such as ethylene glycol monomethyl ether, ethylene glycol monoethyl ether, diethylene glycol methyl ether, diethylene glycol ethyl ether, triethylene glycol monomethyl ether, and triethylene glycol monoethyl ether; a nitrogen compound such as 2-pyrrolidone, N-methyl-2-pyrrolidone, and caprolactam; a dimethyl sulfoxide; a tetramethyl sulfone; a thioglycol; etc. These materials can be used alone or in various combinations thereof.

In one embodiment, the solvent is an organic solvent containing at least water.

In another embodiment, the solvent is an organic solvent containing at least water and alcohol.

In still another embodiment, the solvent is an organic solvent containing at least water and isopropyl alcohol.

Further, the solvent may have a proper ratio when at least two solvents are mixed.

The type and ratio of the solvent may be selected in various combinations depending on a kind of the corresponding polymer, a degree of polymerization, a degree of modification after impact, and so forth.

In one embodiment, when removal of the bulges is carried out using the PMMA as described in examples below, a 1:1 to 1:20 ratio of water to isopropyl alcohol is used.

In another embodiment, when removal of the bulges is carried out using the PMMA as described in examples below, a 1:3 to 1:15 ratio of water to isopropyl alcohol is used.

In still another embodiment, when removal of the bulges is carried out using the PMMA as described in examples below, a 1:5 to 1:10 ratio of water to isopropyl alcohol is used.

However, the aforementioned ratio ranges are merely examples, and may be varied outside of the ranges described above if necessary.

The types of the external stimulus which is applied together with the solvent is not particularly limited, and may include an electric field, a magnetic field, an ultrasonic wave, an electromagnetic wave, vibration, chemical, heat, pressure, etc. These can be used alone or in various combinations thereof.

In one embodiment, the electric field, the ultrasonic wave, the vibration, the heat, or the combination thereof is employed.

In another embodiment, the electric field, the ultrasonic wave or the combination thereof is employed.

Referring again to (c) of FIG. 2, the substrate 100 nanopatterned by the method described above is provided on a metal electrode plate 140 and is brought into contact with a predetermined solvent 130. In one embodiment, the solvent 130 is dropped using a syringe so that the solvent can be uniformly coated on the polymer layer 110. A metal electrode plate 141 is disposed on top of the solvent and the polymer layer 110, and the electric field is applied through a power source 150.

Referring again to (d) of FIG. 2, there is provided a nanostructure having no bulges around a dent hole 111′ and including the dent hole 111′ with increased upper and lower diameters after applying the solvent and electric field, compared with those of the dent hole 111 before treatment.

In one embodiment, although not shown in the drawings, the bulge is removed by applying the ultrasonic wave under the presence of a solvent instead of the electric field. At this time, a sonication using the ultrasonic wave may be carried out while the surface of the nanopatterned polymer is dipped into the solvent. In this case, the treatment time and the sonication power may be properly adjusted to remove the bulge around the dent hole.

As such, according to the method described above, the bulge 112 shown in (c) of FIG. 2 is removed by an interaction between the solvent 130 and the external stimulus, which may be accomplished by adjusting the kind of solvent, the composition ratio, and conditions of applying the electric field or the sonication.

Hereinafter, a procedure of removing the bulge will be described in more detail.

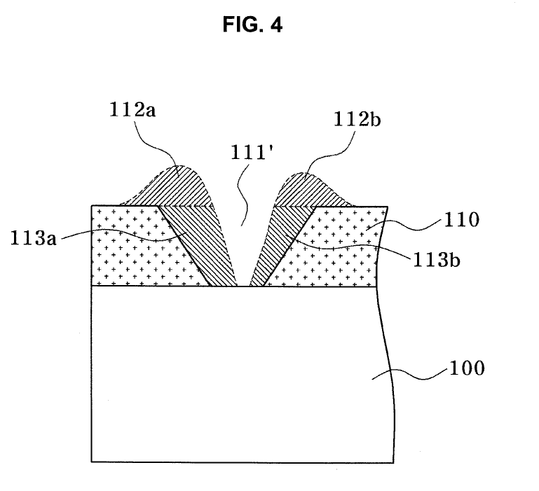

FIG. 4 is a cross-sectional view schematically illustrating the nanopattern before and after the bulges around the nanopattern are removed. As illustrated, portions surrounded by dotted lines indicate a figure of the nanopattern before the surface modification, e.g., right after the nanoindentation, and portions surrounded by solid lines indicate a figure of the nanopattern after the surface treatment. The nanopattern having a dent hole occurs when an impact due to mechanical force of the AFM probe tip is applied to the polymer layer 110 at the time of nanoindentation. When the dent hole is created, a portion of the polymer layer 110 is simultaneously pushed upward to form bulges 112a and 112b. In addition, regions where deterioration occurs may be formed along the circumference of the inner wall and the lower portion of the dent hole due to energy generated by the collision between the probe tip and the polymer layer 110, that is, modified portions 113a and 113b. In addition, sizes of the bulges 112a and 112b and the modified portions 113a and 113b may be different from each other depending on impact conditions. A defect such as a broken polymer chain may be present in the bulges 112a and 112b and the modified portions 113a and 113b.

When bringing a predetermined solvent in contact with the bulges and/or the modified portions where such defects are present as described above and applying a constant external stimulus thereto, only the bulges may be removed or all or some of the bulges and the modified portions 112a, 112b, 113a and 113b may be simultaneously removed depending on the conditions.

Accordingly, the dent hole 111′ without the bulges 112a and 112b is formed on the polymer layer 110. The dent hole 111′ may include an increased upper diameter and an increased inner width compared to those of the dent hole before the surface treatment.

In one embodiment, a nanopattern may be additionally formed in a flat surface exposed by removing the bulges 112a and 112b.

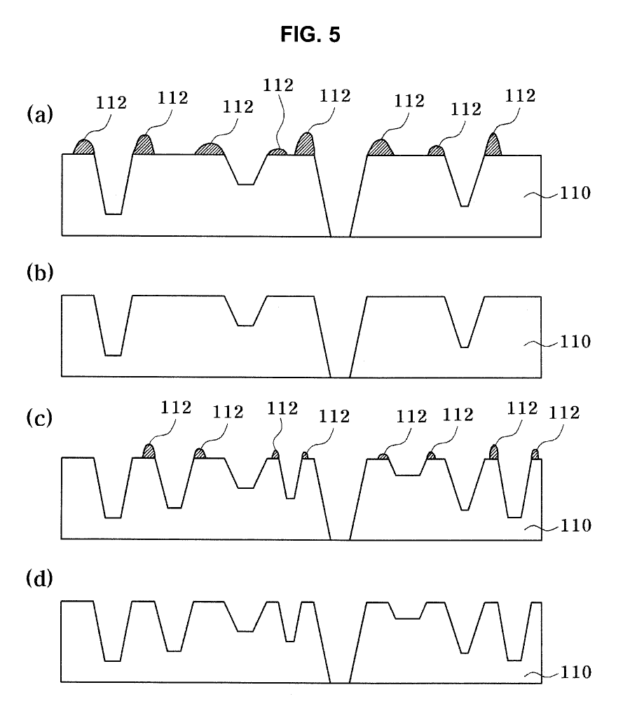

FIG. 5 illustrates a procedure of fabricating a nanostructure in which a nanopattern is additionally formed in positions where bulges are removed.

Referring to FIG. 5, the polymer layer 110 with bulges 112 around the layer 110 is formed by a nanopatterning in step (a). The bulges 112 are removed by a surface treatment in step (b). The nanopatterning is additionally carried out in the positions where the bulges 112 are removed in step (c), and the bulges 112 are removed again by the surface treatment so that the nanostructure having the nanopatterns of various sizes and shapes may be fabricated in step (d).

Therefore, the spacing between the nanopatterns may be reduced, resulting in a finer pattern structure.

According to the method as described above, there is provided little change in the average thickness of the polymer layer even when the bulges and/or the modified portions are totally or partially removed.

In one embodiment, when the electric field is applied under the presence of a predetermined solvent, a direct current (DC) bias or an alternating current (AC) bias used.

[symbol]

[symbol]

The voltage range of applying the DC or AC bias under the presence of the solvent is not limited so long as the voltage range enables the bulges and/or the modified portions to be removed, and a proper voltage range is selected so as to minimize the bulges and/or the modified portions in connection with the solvent to be employed.

As will be seen in examples to be described later, when the solvent containing water and isopropyl alcohol is employed for PMMA, it can be observed that the bulges, and/or the modified portions are reduced or removed at a DC bias voltage of 1 V to 30 V. When the DC bias voltage becomes too low or high beyond the above ranges, the bulges may not be completely removed. Such ranges are merely examples under the limited conditions, and proper ranges may be varied according to kinds of the corresponding polymer and other solvent conditions.

The method according to one embodiment may be applied to various nanostructures. For example, nanotraps having finer patterns, compared to those formed on the polymer layer by using the electron beam, may be formed. Such nanotraps include few bulges and it is easy to adjust the depth and width of the trap holes according to process conditions, so that the nanotraps may be applied to making molecule traps for nanoparticles or making nanojunctions. In addition, when a self-assembled layer is formed using nanoparticles, a bulge effect may be removed so that the degree of freedom between the nanoparticles may be increased.

Embodiments of the present disclosure provide a nanostructure in which the bulges have been removed, i.e., a nanostructure without bulges.

In one embodiment, there is provided a nanostructure including a substrate and a polymer layer with a nanopattern formed on the substrate, wherein bulges around the nanopattern are removed by applying a predetermined solvent and an external stimulus.

Examples of constitutional components including kinds of a polymer, solvent conditions and external stimuli are as follows.

The size of the nanopattern is not limited; whereas, the nanopattern may have a shape of non-continuous dots or a continuous line including holes each having a diameter of 1 μm or less.

In one embodiment, each hole in the nanopattern has a diameter of 500 nm or less. In another embodiment, each hole in the nanopattern has a diameter of 200 nm or less. In still another embodiment, each hole in the nanopattern has a diameter of 100 nm or less. In still another embodiment, each hole in the nanopattern has a diameter of 50 nm or less.

The minimum diameter of the hole may be limited by the standard of the probe tip at the time of forming the nanopattern, for example, at the time of nanoindentation, and may be about 2 nm or greater.

More modified portions inside and outside of the nanopattern may be removed depending on treatment conditions. For example, when the modified portion inside the dent hole is removed, the inner width of the dent hole may be increased.

Further, a flat surface where the bulges around the nanopattern are removed may be utilized to additionally form another nanopattern.

Consequently, the nanostructure may include a hyperfine nanopattern in which the bulges are removed and the shape of the dent hole is close to a circle which could not be easily obtained by the related art.

One embodiment of this nanostructure may be a structure having nanotrap holes. In the structure, nanojunctions may be formed or nanoparticles may be injected into the structure through the holes. A size of the hole may be variously adjusted according to a size of the nanoparticle.

Accordingly, the nanostructure as described above may be applied to various nanodevices such as a nanoimprint mold or a biochip.

Hereinafter, configurations and effects of the present disclosure will be described in detail with respect to specific examples and comparative examples; however, these examples are merely illustrative to make the present disclosure better understood and do not limit the scope of the present disclosure.

### Example 1

### Fabrication of Nano Structure with Removed Bulges by Applying Electric Field

(a) Coating of PMMA on Substrate

A silicon substrate was cleaned with acetone by sonication, and a 4 weight percent PMMA solution (950 K C4) having a molecular weight of 950 K dissolved in a chlorobenzene solvent was spin-coated on the silicon substrate. This was then soft-baked in an oven for 30 minutes at 170° C. to obtain the substrate coated with the PMMA film without pin holes. According to the AFM measurement, the film thickness was 500 nm and the RMS roughness was 0.6 nm.

(b) Formation of Dent Hole by Nanoindentation

Commercially available AFM equipment (SPA-400, Seiko Instruments, Japan) was employed to carry out surface modification, i.e., the nanoindentation, on the PMMA film. A pyramidal silicon probe having a tip diameter of 10 nm, a spring constant of 42 N/m and a resonance frequency of 330 KHz (PPP-NCHR, Nanosensors, Switzerland) was employed to carry out the nanoindentation in tapping mode.

(c) Removal of Bulges Around Dent Hole

A sample nanopatterned by the indentation was put on a copper plate used as a bottom electrode, and a solvent having a proper ratio of deionized water (DI) and isopropyl alcohol (IPA) was dropped on the sample using a syringe to coat the surface of the sample. Another copper plate used as a top electrode was disposed above the sample surface with an interval of 1 mm therebetween, and the DC or AC bias were applied for 20 minutes to remove bulges.

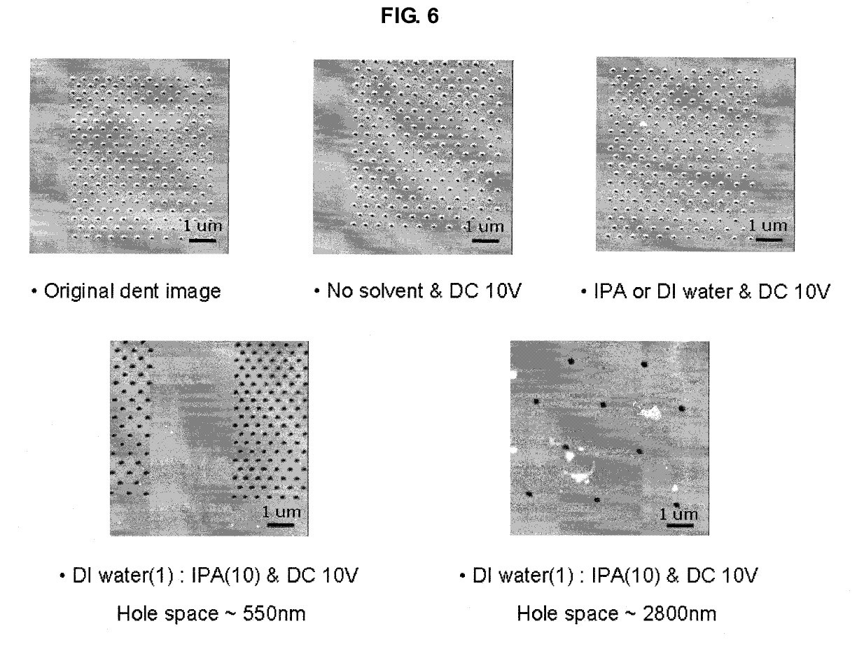

Changes in bulge height according to changes in composition ratio of a solvent, a seamier extension value, and a magnitude of the DC or AC bias voltage were illustrated in Tables 1 to 3 below and FIGS. 6 to 10B.

### Example 2

### Fabrication of Nanostructure with Removed Bulges by Applying Ultrasonic Wave

The nanoindentation was carried out to form the dent hole under the same conditions as (a) and (b) of Example 1, except that a silicon substrate coated with a film having a thickness of 70 nm and an RMS roughness of 0.6 nm using a 2 weight percent PMMA solution (950 K A2) having a molecular weight of 950 K dissolved in anisole instead of chlorobenzene was employed.

An ultrasonic processing apparatus (JAC Ultrasonic 1002, Frequency=40 KHz, power=125 W, KODO Technical Research) was employed to apply the ultrasonic wave for 5 minutes in a solvent having a 1:5 ratio of DI:IPA.

In addition, the nanoindentation as described above was carried out to form nanopatterns of triangular, rectangular and hexagonal shapes made of continuous lines, and the ultrasonic wave was applied for 5 minutes in a solvent having a 1:5 ratio of DI:IPA.

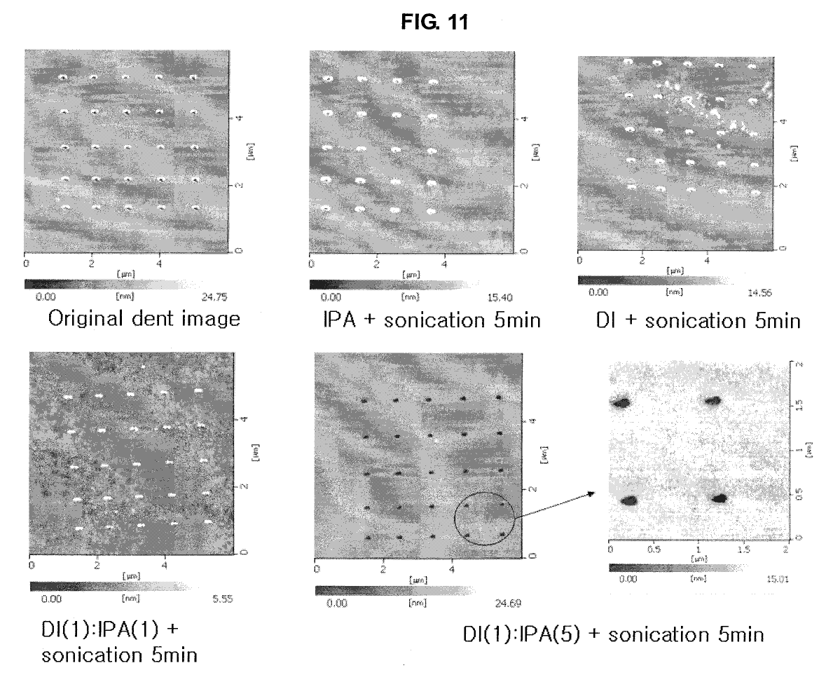

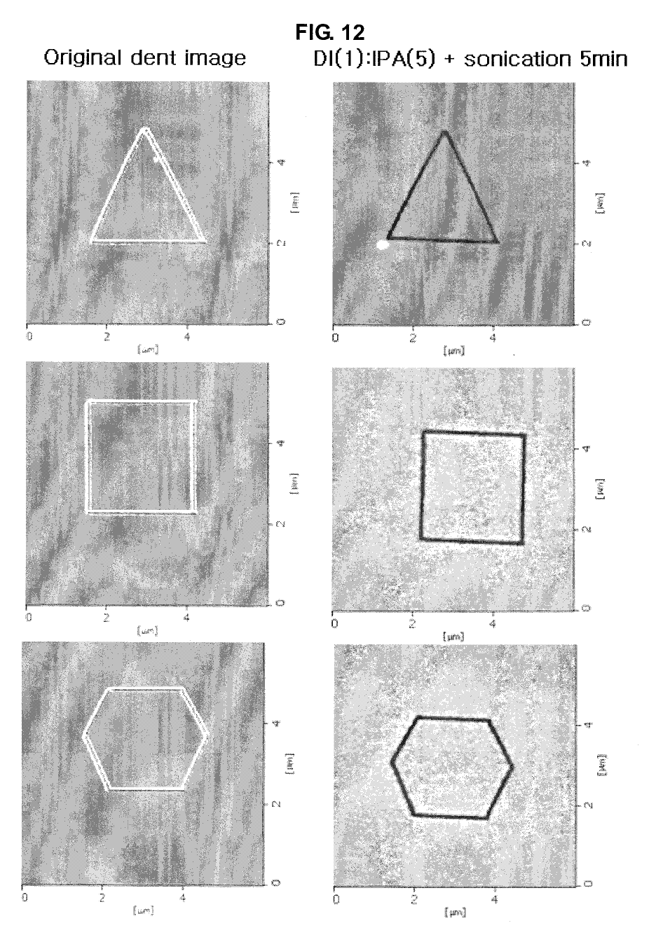

Surfaces before and after the surface treatment were observed by AFM, and the results were illustrated in FIGS. 11 and 12.

### Evaluation

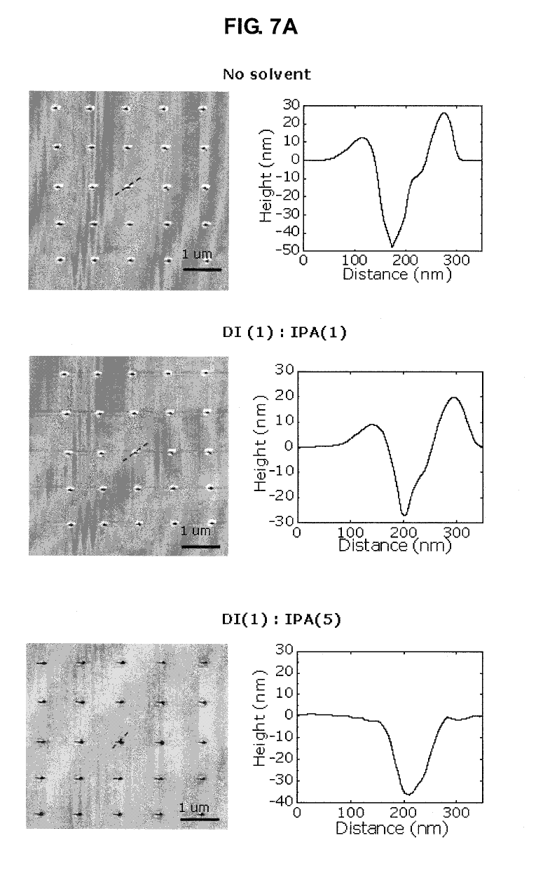

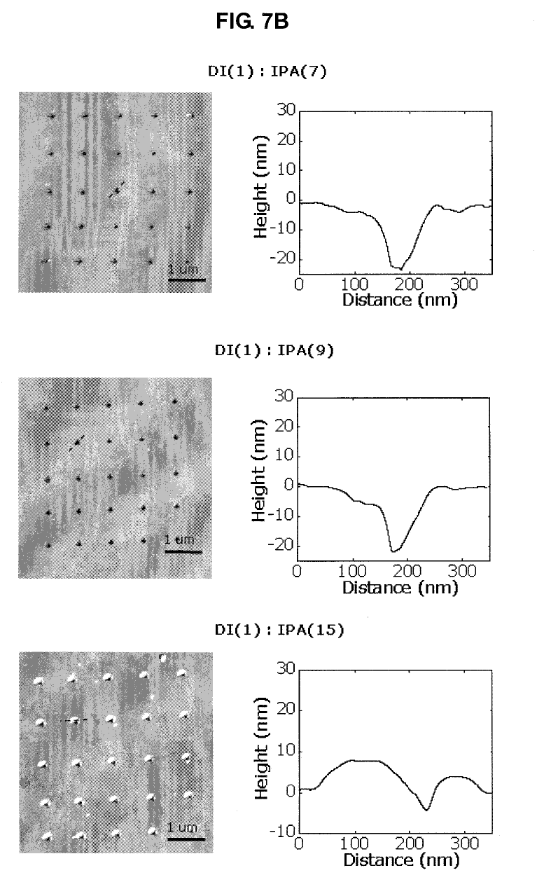

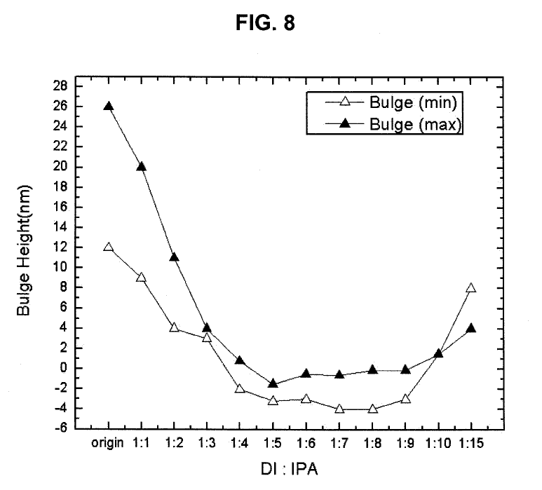

FIG. 6 shows surface AFM images before and after the DC bias is applied according to the solvent compositions. In addition, FIG. 7 shows surface and cross-sectional AFM images representing structures of holes and bulges according to various solvent compositions when the DC bias is applied. In addition, FIG. 8 is a graph illustrating changes in bulge height according to the respective solvent compositions when the DC bias is applied.

Referring to FIG. 6, it can be seen that the dent hole before the surface modification, e.g., right after the nanoindentation, has a triangular shape, and the bulges are not removed but present as in the indentation described above in the cases where only the DC 10 V (E=1.0×10⁴ V/m) is applied without a solvent, deionized water (DI) and DC 10 V are applied, and isopropyl alcohol (IPA) and DC 10 V are applied. In contrast, when a mixed solution having a 1:10 volume ratio of DI to IPA is used, it can be observed that the bulges around the dent hole are removed and the hole has a circular shape.

Referring to FIGS. 7A and 7B, images of left columns represent surface images after the surface modification according to respective solvent compositions, and images of the right column represent cross-sectional images.

Referring to FIG. 8 and Table 1 below, it can be seen that the bulges are gradually removed when the ratio of IPA to DI increases and are almost removed when DI:IPA ratio is about 1:5. The bulges appear again when the rate of the IPA increases.

TABLE 1
Changes in bulge height according to solvent composition ratio

| | DI:IPA | DC | Min. Bulge | Max. Bulge |
|---|---|---|---|---|
| No. | (Volume Ratio) | Bias (V) | Height (nm) | Height (nm) |
| Comparative | — | — | 12 | 26 |
| Example 1 | | | | |
| 1 | 1:1 | 10 | 9 | 20 |
| 2 | 1:2 | 10 | 4 | 11 |
| 3 | 1:3 | 10 | 3 | 4 |
| 4 | 1:4 | 10 | −2 | 0.8 |
| 5 | 1:5 | 10 | −3.2 | −1.5 |
| 6 | 1:6 | 10 | −3 | −0.5 |
| 7 | 1:7 | 10 | −4 | −0.6 |
| 8 | 1:8 | 10 | −4 | −0.1 |
| 9 | 1:9 | 10 | −3 | −0.1 |
| 10 | 1:10 | 10 | 1.5 | 1.5 |
| 11 | 1:15 | 10 | 4 | 8 |

* PMMA 950 K C4, thickness: 500 nm, hole depth = 45 nm, scanner extension (Δz) = 80 nm

The bulge height also depends on the scanner extension (Δz). The bulge height before applying the electric field and the solvent into the sample increases with the increased force applied to an AFM tip, which is indicated in Table 2 below. That is, the hole depth and the bulge height increase when Δz increases from 60 nm to 80 nm. In contrast, when applying the solvent and the electric field into the sample after the nanoindentation, the bulge is removed and the sample has a minimum value of bulge height when Δz is 80 nm.

TABLE 2
Changes in bulge height according to scanner extension

| | Scanner | Hole | Max. Bulge | Max. Bulge |
|---|---|---|---|---|
| | Extension | Depth | Height Before | Height After |
| No. | (Δz)(nm) | (nm) | Treatment (nm) | Treatment (nm) |
| 12 | 60 | 38 | 22 | 10 |
| 13 | 70 | 51 | 28 | 4 |
| 14 | 80 | 59 | 33 | 0.7 |

* PMMA 950 K C4, thickness: 500 nm, DI:IPA (volume ratio) = 1:5, DC bias (V) = 10 V (E = 1.0 × 10⁴ V/m)

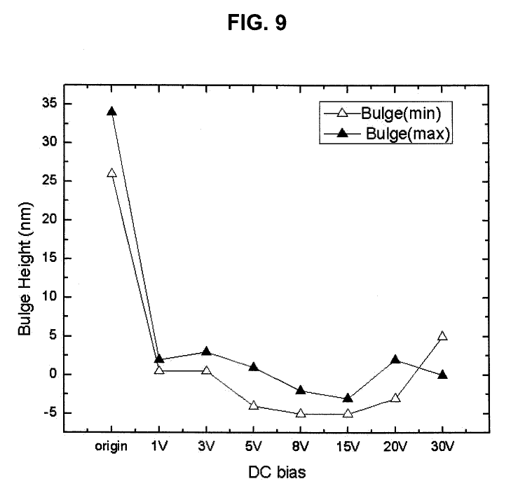

FIG. 9 is a graph illustrating changes in bulge height according to changes in DC bias.

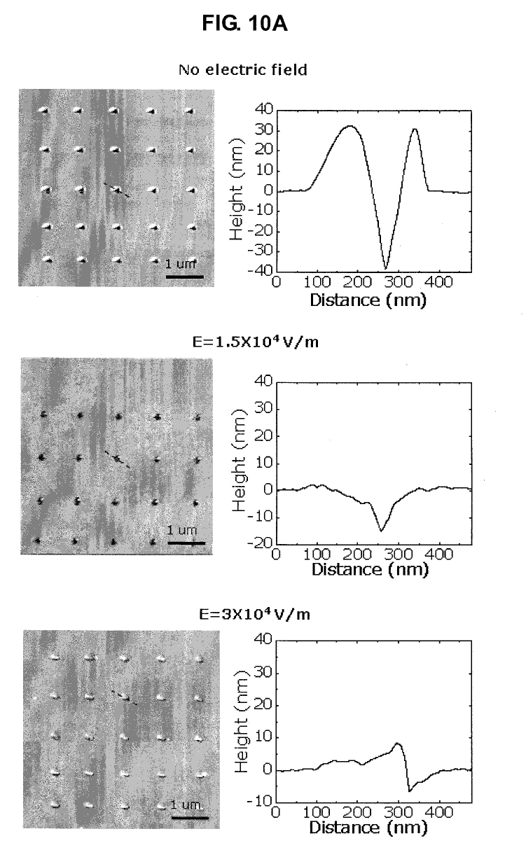

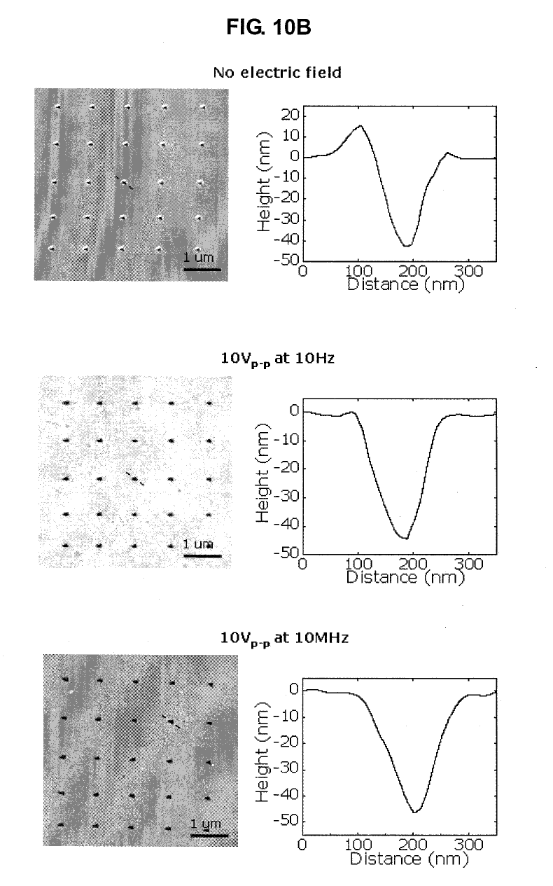

FIG. 10A shows surface and cross-sectional AFM images representing structures of bulges and holes according to changes in DC bias. FIG. 10B shows surface and cross-sectional AFM images representing structures of bulges and holes according to changes in AC bias.

Results of the change in bulge height according to an applied DC bias voltage are shown in Table 3 below, and referring to FIGS. 9 and 10A, it can be seen that the bulges are removed in a range of about DC 5 V (E=5.0×10³ V/m) to about 15 V (E=1.5×10⁴ V/m) using a solvent having a 1:10 ratio of DI:IPA and are not completely removed when the bias voltage is applied beyond the above-mentioned range. Referring to FIG. 10B, it can be seen that the bulges are removed within a frequency range of 10 Hz-10 MHz at 10 Vₚ₋ₚ using AC bias voltages. Thus, alteration of AC frequency appeared to have little influence on variation in bulge removal.

TABLE 3
Change in bulge height according to an applied DC bias voltage

| | DI:IPA | DC | Min. Bulge | Max. Bulge |
|---|---|---|---|---|
| No. | (Volume Ratio) | Bias (V) | Height (nm) | Height (nm) |
| Comparative | — | — | 26 | 34 |
| Example 2 | | | | |
| 15 | 1:10 | 1 | 0.5 | 2 |
| 16 | 1:10 | 3 | 0.5 | 3 |
| 17 | 1:10 | 5 | −4 | 1 |
| 18 | 1:10 | 8 | −5 | −2 |
| 19 | 1:10 | 15 | −5 | −3 |
| 20 | 1:10 | 20 | −3 | 2 |
| 21 | 1:10 | 30 | −5 | 0 |

* PMMA 950 K C4, thickness: 500 nm, hole depth = 94 nm, scanner extension (Δz) = 80 nm

FIG. 11 shows surface AFM images before and after sonication according to solvent compositions.

Referring to FIG. 11, it can be seen that the dent hole before surface modification, e.g., right after nanoindentation, has a triangular shape. After surface modification, in cases of applying only the sonication for 5 minutes without solvents, applying DI and sonication for 5 minutes, and applying IPA and sonication for 5 minutes, the bulges around the dent hole are not removed from the samples. In contrast, when a mixed solution having a 1:5 volume ratio of DI to IPA is used, it can be observed that the bulges around the dent hole are removed from the sample and the shape of the hole becomes circular.

FIG. 12 shows AFM images before and after surface treatment of sonication with respect to a PMMA surface patterned in a line shape using the nanoindentation.

Referring to FIG. 12, when performing surface treatment under conditions of DI(1):IPA(5) and sonication for 5 minutes after forming a continuous dent hole by indentation at a predetermined interval to become a line pattern, it can be seen that triangular, rectangular, and hexagonal patterns are clearly formed without any bulges compared with an original dent image. When performing the indentation at an interval of 45 nm before the surface treatment, the width of the line pattern is about 40 nm The bulge also has a height of about 12 nm and a width of about 80 nm. After the bulges are removed by the surface treatment, it can be seen that a clear line of about 120 nm are formed with an original line width and a bulge width.

The foregoing is illustrative of the present disclosure and is not to be construed as limiting thereof. Although numerous embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

1-21. (canceled)

22. A method comprising:
forming a nanopattern on a surface of a polymer;
contacting the surface of the polymer on which the nanopattern is formed with a solvent; and
applying an external stimulus to the surface of the polymer contacting the solvent to remove at least one bulge around the nanopattern.

23. The method according to claim 22, wherein the nanopattern is formed by a mechanical force.

24. The method according to claim 22, wherein the nanopattern is formed by at least one of a nanoindentation and nanoimprinting.

25. The method according to claim 24, wherein the nanoindentation comprises using a tapping mode atomic force microscope.

26. The method according to claim 22, wherein the polymer comprises at least one of a polyoxymethylene, polyacryl, polymethyl methacrylate, polystyrene homopolymer, polystyrene copolymer, styrene acrylonitrile, acrylonitrile butadiene styrene, high impact polystyrene, polycarbonate, polyethylene, polypropylene homopolymer, polypropylene copolymer, polyethylene terephthalate, glycol-modified polyethylene terephthalate, polybutylene terephthalate, polyether-ester copolymers, polyether-amide copolymers, Nylon 6, Nylon 6,6, Nylon 6,10, Nylon 6,12, Nylon 11, Nylon 12, polyamide-imides, polyarylates, polyurethanes, ethylene propylene rubber, ethylene propylene diene monomer, polyarylsulfone, polyethersulfone, polyphenylene sulfide, polyphenylene oxide, polyvinyl chloride, polysulfone, polyetherimide, polytetrafluoroethylene, fluorinated propylene ethylene, polyfluoroalkoxy, polychlorotrifluoroethylene, polyvinylidene fluoride, polyvinyl fluoride, polyetherketone, polyetheretherketone and polyetherketoneketone.

27. The method according to claim 22, wherein the polymer comprises at least one of a photoresist, an electron beam resist and an X-ray resist.

28. The method according to claim 22, wherein the external stimulus comprises at least one of an electric field, a magnetic field, an ultrasonic wave, an electromagnetic wave, a vibration, a chemical, heat and pressure.

29. The method according to claim 28, wherein the electric field is formed by a direct current bias.

30. The method according to claim 22, wherein at least one of a type and a composition ratio of the solvent is selected such that the solvent includes a polarity sufficient to remove the at least one bulge when the external stimulus is applied.

31. The method according to claim 22, wherein the solvent comprises at least one of:
water;
an alcohol, including at least one of a methyl alcohol, ethyl alcohol, n-propyl alcohol, isopropyl alcohol, n-butyl alcohol, sec-butyl alcohol, tbutyl alcohol and isobutyl alcohol;
a ketone, including at least one of a acetone, methyl ethyl ketone and diacetone alcohol;
an ester, including at least one of a ethyl acetate and ethyl lactate;
a polyhydric alcohol, including at least one of a ethylene glycol, diethylene glycol, triethylene glycol, propylene glycol, butylene glycol, 1,4-butanediol, 1,2,4-butanetriol, 1,5-pentanediol, 1,2-hexanediol, 1,6-hexanediol, 1,2,6-hexanetriol, hexylene glycol, glycerol, glycerol ethoxylate and trimethylol propane ethoxylate;
a lower alkyl ether, including at least one of a ethylene glycol monomethyl ether, ethylene glycol monoethyl ether, diethylene glycol methyl ether, diethylene glycol ethyl ether, triethylene glycol monomethyl ether and triethylene glycol monoethyl ether;
a nitrogen compound, including at least one of a 2-pyrrolidone, N-methyl-2-pyrrolidone and caprolactam;
a dimethyl sulfoxide;
a tetramethyl sulfone; and
a thioglycol.

32. The method according to claim 22, wherein the solvent is an organic solvent comprising water.

33. The method according to claim 22, wherein the solvent is an organic solvent comprising at least one of water and an alcohol.

34. The method according to claim 22, wherein the solvent is an organic solvent comprising at least one of water and an isopropyl alcohol.

35. The method according to claim 22, wherein removing the at least one bulge comprises removing at least one modified portion of the nanopattern.

36. The method according to claim 22 comprising:
forming a nanopattern in at least one position where the at least one bulge is removed.

37. The method according to claim 22, wherein the surface of the polymer excluding the at least one bulge is unetched when removing the at least one bulge.

38. A nanostructure comprising:
a substrate; and
a polymer layer comprising a nanopattern formed on the substrate,
wherein at least one bulge around the nanopattern is removed by applying a predetermined solvent and an external stimulus.

39. The nanostructure according to claim 38, wherein the nanopattern has a shape comprising at least one of non-continuous dots and continuous lines, including holes with a diameter of approximately 1 μm or less.

40. The nanostructure according to claim 38, wherein the polymer layer comprises at least one of a photoresist, an electron beam resist and an X-ray resist.

41. The nanostructure according to claim 38, wherein the nanopattern comprises at least one modified portion, wherein the at least one modified portion is removed during applying the predetermined solvent and the external stimulus.

42. The nanostructure according to claim 38, comprising a nanopattern formed in at least one position where the at least one bulge is removed.
